(19) United States
(12) Patent Application Publication
(10) Pub. No.: US 2006/0274669 A1
(43) Pub. Date: Dec. 7, 2006

(54) Discovering proximate apparatus and services in a wireless network

(76) Inventors: Thomas Falck, Aachen (DE); Javier Espina Perez, Aachen (DE); Henning Maass, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/550,882

(22) PCT Filed: Mar. 24, 2004
(86) PCT No.: PCT/IB04/00952

§ 371 Date: Sep. 27, 2005

(30) Foreign Application Priority Data
Apr. 1, 2003 (EP) 03100855.0

(51) Int. Cl. H04L 12/28; H04Q 7/00

(52) U.S. Cl. 370/254; 370/328

(57) ABSTRACT

A searching apparatus in a wireless network with at least three base stations is put in the position of identifying the available apparatuses and services which are in its proximity, in that the apparatuses Gᵢ(i≠k) determine the signal strengths ss(i,j) at which they receive signals from the base stations Bᵢ, and the apparatuses to be discovered send these signals to a searching apparatus Gₖ.

The invention relates to a method enabling apparatuses in a wireless network (wireless LAN, WLAN) to discover other apparatuses and services in their proximity.

Wireless networks in spatially bounded areas (referred to as local area networks, LAN) are used within very wide fields. A field of application is, for example, computer-LAN in which a plurality of computers and a plurality of peripheral apparatuses such as printers, scanners, projectors, etc. are combined. These LANs are widely used in, for example, companies. They usually have a plurality of access points (AP) via which a user can connect to a portable WLAN-capable apparatus in the network and can thus use, for example, the company's main frame computer. Moreover, the use of generally available peripheral apparatuses such as printers, scanners, UHP projectors, etc. is made possible in that they are also connected to the network and can be accessed by several users. This provides the possibility of, for example, the fixed installation of the peripheral apparatuses in conference rooms, in which a lecturer or speaker only needs to connect his laptop to the network for communication with the peripheral apparatus.

This poses the problem that the apparatus which is in closest proximity must be occasionally selected from a plurality of equivalent apparatuses. For example, when a user with a laptop searches a printer in a building which is unknown to him, he is interested in finding the printer which is in closest proximity to his current location, rather than a printer which may be present in another building or on another floor.

Without corresponding pre-configuration by a network administrator (for example, a list of names comprising indications of locations), the current state of the art does not provide the possibility of determining the services that are in the proximity of the user's own apparatus. In order that wireless apparatuses (network elements) can be unambiguously assigned to a given network, they should either know the identification of the network, or the network must ensure the assignment with reference to an unambiguous identification of the wireless apparatus. Both techniques are used in practice.

In the IBSS mode of the 802.11 standard, a network name is entered into all wireless apparatuses as an identification of the network. Only apparatuses that have the same entered name can communicate with each other.

An example of the configuration by the network or a fixed institution in the network is provided by DHCP. A DHCP server has a list of unambiguous apparatus addresses (MAC addresses) and an assignment to an IP address. For its MAC address, a new apparatus then requires an IP address with which it is then assigned to the network in so far as it is present in the list of the DHCP server.

Both techniques require the pre-configuration of the assignment of apparatuses to networks, either in each individual apparatus by means of a common network identification, or by means of a central authority in the network requiring a list of the assigned apparatuses. If a new apparatus is to be assigned to an existing network, it must either be provided with the network identification, or the network must know the unambiguous identification of the new apparatus. Typically, these adjustments are made manually.

The current Discovery Frameworks such as, for example, Universal Plug&Play (UPnP) provide the possibility of discovering apparatuses and services which can be reached via the network or are available in the network. However, in the current state of the art, it is not possible to limit the discovery only to the apparatuses in close proximity because there is no information available about the distance between apparatuses. A search by means of Universal Plug&Play (UPnP) will find all appropriate apparatuses and services which are present in the same network. Consequently, the number of discovered apparatuses may be very large. The user can search known names on the list of apparatuses that have been found or download a description page from the network for each apparatus, on which page he can search information about the location of the apparatus. This, of course, pre-supposes that the user has knowledge about the environment and it requires user interaction.

It is an object of the present invention to provide a method enabling an apparatus to identify the available apparatuses and services that are in its proximity.

It was found that the distance between the WLAN-capable portable apparatuses and other apparatuses and services, i.e. its relative position to them, can be determined and used when the apparatuses to be discovered in the local wireless network are in contact with at least three base stations and determine the signal strengths at which they receive signals from the base stations and send the signals to a searching apparatus.

It is an object of the present invention to provide a method of discovering proximate apparatuses and services in a wireless network comprising at least three base stations (Bⱼ), in which all apparatuses Gᵢ(i≠k) determine the signal strengths ss(i,j) at which they receive signals from the base stations Bⱼ, and the apparatuses to be discovered send these signals to a searching apparatus Gₖ.

The method according to the invention enables a WLAN-capable apparatus, which is connected to at least three base stations, to discover and identify other proximate apparatuses and their services. In this way, new, proximity-based applications become possible. Moreover, the method according to the invention has the advantage that the infrastructure of the WLAN does not need to be changed. The method according to the invention is directly applicable for use with available apparatuses because the WLAN technology is already widely used.

The method according to the invention is particularly suitable when a user having a wireless mobile apparatus would like to discover and use services in his proximity. Examples of such services are printer, projector, music player and imaging services.

Both the mobile apparatus of the user (hereinafter also referred to as “searching apparatus”) and the apparatuses providing services (hereinafter also referred to as “apparatuses to be discovered”) are in contact with at least three base stations and belong to the same network within which they can communicate with each other. In buildings, a base station can cover a range of about 100 meters. Larger areas, such as the company grounds, can be serviced by a wireless network by connecting a plurality of base stations covering the area.

In the case of two apparatuses, which are present at the same location, the signal strengths of the signals received by these apparatuses from the base stations are substantially equal. Since the signal strength is a function of the distance between the apparatus and the relevant base station in the case of a given transmitter capacity, the distances between the two apparatuses, estimated from the signal strength, are also substantially equal. The more similar the distance information about two apparatuses, the closer these apparatuses are to each other.

The method according to the invention will hereinafter be elucidated, using the following references:

ss(i,j): signal strength measured in [dBm] at which the apparatus Gᵢ receives the signals from the base station Bⱼ.

r(i,j): (estimated) distance in [m] between the apparatus Gᵢ and the base station Bⱼ, derived from the signal strength ss(i,j).

σ(i,j): standard deviation of the derived distance information for apparatus Gᵢ from that of apparatus Gⱼ.

The distance r between an apparatus and a base station in a wireless network can be determined from the signal strength ss. For the case of a wireless 802.11b network operating in the 2.4 GHz band, there applies:

$$r [ m ] = {10}^{( \frac{- ss [ dBm ] - 40 , 17}{20} )}$$

By means of this formula, the associated distance r(i,j) between an apparatus Gᵢ and a base station Bⱼ can be computed for each signal strength ss(i,j):

$$r ( i , j ) = {10}^{( \frac{- ss ( i , j ) - 40 , 17}{20} )}$$

For every two apparatuses Gᵢ and Gⱼ, the standard deviation σ(i,j) with respect to their associated distance estimations can be determined as follows:

$$σ ( i , j ) = \sqrt{{( r ( i , 1 ) - r ( j , 1 ) )}^{2} + ( r ( i , 2 ) - {r ( j , 2 )}^{2} + … + {( r ( i , m ) - r ( j , m ) )}^{2}}$$

The method according to the invention enables the searching apparatus Gₖ to determine which apparatuses Gᵢ (i≠k) are in its spatial proximity. To this end, the apparatuses Gᵢ (i≠k) to be discovered determine the signal strengths ss(i,j) at which they receive signals from the base stations Bⱼ and send the signals to the searching apparatus Gₖ.

In the preferred method according to the invention, the searching apparatus Gₖ utilizes this information for computing the distances r(i,j) of all apparatuses Gᵢ (i≠k) to be discovered from the signal strengths ss(i,j). Additionally, the searching apparatus Gₖ determines its own signal strengths ss(k,j) at which it receives signals from the base stations Bⱼ and, from the strengths, it computes its distances r(k,j) to the base stations Bⱼ.

Subsequently, the searching apparatus Gₖ can determine the standard deviations σ(k,i).

The searching apparatus Gₖ can assign a given value of a standard deviation σ(k,i) to each apparatus Gᵢ (i≠k) to be discovered, which deviation is a measure of the distance between the apparatuses Gₖ and Gᵢ. When the searching apparatus Gₖ assigns these values in accordance with their magnitude, the apparatus Gⱼ having the smallest standard deviation is the apparatus which is spatially closest to Gₖ. Accordingly, the preferred method according to the invention is performed in the following steps:
all apparatuses Gᵢ with i ε {1,2, . . . , n} determine their own signal strengths ss(i,j) at which they receive signals from the base stations Bⱼ, for all j ε {1,2, . . . , m};
all apparatuses Gᵢ (i≠k) to be discovered send their signal strengths ss(i,j) to the searching apparatus Gₖ ;
from these signal strengths, the searching apparatus Gₖ determines the distances r(i,j) between apparatus Gᵢ and base station Bⱼ for all i ε {1,2, . . . , n} and for all j ε {1,2, . . . , m};
subsequently, the searching apparatus Gₖ determines the standard deviations σ(k, i) for all i ε {1,2, . . . , n}, i≠k as a measure of the distance between apparatuses Gₖ and Gᵢ;
the apparatus Gⱼ having the smallest standard deviation (i.e. σ(k,j)≦σ(k, i)) for all i ε {1,2, . . . , n}, i≠k) is the apparatus which is spatially closest to Gₖ.

The method described hereinbefore enables an apparatus to be assigned to other apparatuses as far as their relative distance is concerned and thus to determine the spatially closest apparatus. It does not give information about the absolute extent of the distance between the apparatuses that have been found and the searching apparatus. However, the method according to the invention can be supplemented so as to provide this information as well. In this case, the following references are used.

d(i,j): Actual distance between apparatus Gᵢ and apparatus Gⱼ .

dₘᵢₙ(i,j):Lower limit for the distance the apparatuses Gᵢ and Gⱼ at least have with respect to each other.

dₘₐₓ(i,j):Upper limit for the distance the apparatuses Gᵢ and Gⱼ at most have with respect to each other.

For every two apparatuses Gᵢ and Gⱼ a lower and an upper limit can be determined for the mutual distances:
dₘᵢₙ(i,j):=min{|r(i,1)−r(j,1)|,|r(i,2)−r(j,2)|, . . . |r(i,m)−r(j,m)|}
dₘₐₓ(i,j):=max{|r(i,1)+r(j,1)|,|r(i,2)+r(j,2)|, . . . |r(i,m)+r(j,m)|}

For the actual distance, there applies:
dₘₐₓ≧d(i,j)≧dₘᵢₙ

This can be utilized, for example, when the apparatus Gₖ is only interested in apparatuses Gᵢ which are not further remote than, for example, ten meters.

To this end, the apparatus Gₖ computes the lower limit dₘᵢₙ(k, i) for all other apparatuses Gᵢ (i≠k), particularly for apparatuses to be discovered. In any case, apparatuses Gᵢ with dₘᵢₙ(k,i)>10 m are further than 10 m remote from Gₖ and are therefore not further considered by the apparatus Gₖ in the further search.

For all other apparatuses Gᵢ, particularly apparatuses to be discovered (i.e. all apparatuses with dₘᵢₙ(k, i)≦10 m), the apparatus Ok now computes the upper limit dₘₐₓ(k, i). In any case, apparatuses Gᵢ with dₘₐₓ(k, i)≦10 m are not further than 10 m remote from Gₖ and only these apparatuses are further considered by the apparatus Gₖ.

The apparatus Gₖ now computes the maximum σₘₐₓ from the standard deviations σ(k, i) of the remaining apparatuses Gᵢ, (i.e. all apparatuses with dₘᵢₙ(k, i)≦10 m and dₘₐₓ(k, i)≦10 m). The value σₘₐₓ thus determined is the largest standard deviation which is known to the apparatus Gₖ as to belong to an apparatus which is certainly not further than 10 m remote from it.

All apparatuses which have no higher standard deviation than σₘₐₓ (i.e. all apparatuses Gₚ with σ(k, p)≦σₘₐₓ) are then neither more than 10 m remote from Gₖ.

In summary, methods according to the invention are preferred in which the searching apparatus Gₖ computes lower and upper limits dₘᵢₙ(k, i) and dₘₐₓ(k, i) for apparatuses Gᵢ(i≠k) to be discovered and utilizes these values so as to determine the absolute extent of the distance of the apparatuses.

As mentioned hereinbefore, the method according to the invention requires at least three base stations. The accuracy of the method according to the invention increases with the number of base stations, because there are more data available for computing the standard deviation which can thus be computed in a more exact way.

In the preferred method according to the invention, the wireless network comprises at least four, preferably at least five, particularly preferably at least six and particularly at least seven base stations (Bⱼ ).

The accuracy of the method according to the invention can also be further increased without additional base stations in that the quantity of information about the signal strengths transmitted by the apparatuses Gᵢ to be discovered to the searching apparatus Gₖ is improved. This can be achieved in that not only the last measured signal strengths are taken into account, which may have the risk that they are erroneous values. In the preferred embodiment according to the invention, each or all apparatuses Gᵢ to be discovered rather forms a mean value from the signal strengths ss(i,j) measured within a given period of time and sends this mean value to the searching apparatus Gₖ which uses the mean value for computing the distances.

In the preferred embodiment according to the invention, the period of time within which the apparatuses Gᵢ to be discovered average the signal strengths ss(i,j) is 2 to 60 seconds, preferably 5 to 40 seconds and particularly 8 to 20 seconds.

In order that the apparatuses to be discovered need not wait too long for the separate data quantities, it is recommendable for these apparatuses to send their information regularly. In the preferred method according to the invention, the repetition frequency at which the apparatuses Gᵢ (i≠k) send their, preferably averaged, signal strengths ss(i,j) to the searching apparatus Gₖ is 0.1 to 50 Hz, preferably 0.25 to 25 Hz, particularly preferably 0.5 to 20 Hz and particularly 1 to 10 Hz.

In the manner described hereinbefore, the user of the searching apparatus acquires a list of those apparatuses to be discovered that are in his proximity. To find out whether a service desired by the user is in his proximity, the method according to the invention can be performed in such a way that, by means of a Discovery Framework, preferably by means of Universal Plug&Play (UPnP), the searching apparatus Gₖ is capable of accessing the services of the apparatuses Gᵢ (i≠k) to be discovered.

In this variant of the method, the searching apparatus starts a UPnP search among the discovered apparatuses after it has discovered at least one apparatus in its proximity. UPnP ensures that the searching apparatus finds and can use the services offered by the other apparatus. The user can then be informed about appropriate services in his proximity.

In the preferred method according to the invention, the searching apparatus Gₖ finds that apparatus which provides the desired service by means of a Universal Plug&Play (UPnP) search among the apparatuses Gᵢ(i≠k) to be discovered.

This variant of the method can also be performed in that initially all proximate apparatuses are found and the appropriate service is searched among these apparatuses; it is alternatively possible to start a search request for an appropriate service and search, among the apparatuses providing the appropriate service, the apparatus which is in spatially closest proximity. Accordingly, methods according to the invention are preferred in which, in the case of replies to search requests, each apparatus Gᵢ(i≠k) to be discovered adds information about the signal strengths ss(i,j) to the base stations Bⱼ with which it is in radio contact.

This information allows the searching apparatus to determine spatially proximate apparatuses and services in the manner described hereinbefore.

1. A method of discovering proximate apparatuses and services in a wireless network comprising at least three base stations (Bⱼ ), in which all apparatuses Gᵢ (i≠k) determine the signal strengths ss(i,j) at which they receive signals from the base stations Bⱼ, and the apparatuses to be discovered send these signals to a searching apparatus Gₖ.

2. A method as claimed in claim 1, wherein the searching apparatus Gₖ computes the distances r(i,j) of all apparatuses Gᵢ (i≠k) to be discovered from the signal strengths ss(i,j) and determines the standard deviations σ(i,j).

3. A method as claimed in claim 1, wherein the searching apparatus Gₖ computes lower and upper limits dₘᵢₙ(k, i) and dₘₐₓ(k, i) for apparatuses Gᵢ (i≠k) to be discovered and utilizes these values so as to determine the absolute extent of the distance of the apparatuses.

4. A method as claimed in claim 1, wherein the wireless network comprises at least four, preferably at least five, particularly preferably at least six and particularly at least seven base stations (Bⱼ ).

5. A method as claimed in claim 1, wherein all apparatuses Gᵢ to be discovered form a mean value from the signal strengths ss(i,j) measured within a given period of time and send this mean value to the searching apparatus Gₖ which utilizes the mean value for computing the distance.

6. A method as claimed in claim 5, wherein the period of time is 2 to 60 seconds, preferably 5 to 40 seconds and particularly 8 to 20 seconds.

7. A method as claimed in claim 5, wherein the repetition frequency at which the apparatuses Gᵢ (i≠k) to be discovered send their, preferably averaged, signal strengths ss(i,j) to the searching apparatus Gₖ is 0.1 to 50 Hz, preferably 0.25 to 25 Hz, particularly preferably 0.5 to 20 Hz and particularly 1 to 10 Hz.

8. A method as claimed in claim 1, wherein, by means of a Discovery Framework, preferably by means of Universal Plug&Play (UPnP), the searching apparatus Gₖ is capable of accessing the services of the apparatuses Gᵢ (i≠k) to be discovered.

9. A method as claimed in claim 8, wherein the searching apparatus Gₖ finds, by means of a Universal Plug&Play (UPnP) search among the apparatuses Gᵢ (i≠k) to be discovered, that apparatus which provides the desired service.

10. A method as claimed in claim 8, wherein, in the case of replies to search requests, each apparatus Gᵢ (i≠k) to be discovered adds information about the signal strengths ss(i,j) to the base stations Bⱼ with which it is in radio contact.
